(19) United States
(12) Patent Application Publication
(10) Pub. No.: US 2025/0290004 A1
(43) Pub. Date: Sep. 18, 2025

(54) NATURAL GAS PROCESSING WITH CO-GENERATION OF POWER

(71) Applicant: Sapphire Technologies, Inc., Cerritos, CA (US)

(72) Inventors: Jeffrey Earl, Hermosa Beach, CA (US); Steve Richards, Cerritos, CA (US); John Stout, Long Beach, CA (US)

(21) Appl. No.: 18/608,544

(22) Filed: Mar. 18, 2024

(51) Int. Cl. C10L 3/10; B01D 53/18; B01D 53/26; F03B 13/06

(52) U.S. Cl. CPC C10L 3/106; B01D 53/18; B01D 53/263; F03B 13/06; B01D 2252/2023; B01D 2257/80; C10L 2290/541; F05B 2220/706

(57) ABSTRACT

A system for processing a natural gas stream includes a flow-through turboexpander generator, a throttle valve, a knockout separator, and an absorption separator. The flow-through turboexpander generator is configured to receive a first portion of the natural gas stream and generate electrical power in response to expansion of the first portion of the natural gas stream. The throttle valve is configured to reduce a pressure of a second portion of the natural gas stream. The knockout separator is configured to receive the first portion of the natural gas stream from the flow-through turboexpander generator and configured to separate phases of the first portion of the natural gas stream to produce at least a gaseous phase and an aqueous phase. The absorption separator is configured to receive the gaseous phase from the separator vessel and separate water from the gaseous phase to produce a dehydrated natural gas stream.

### TECHNICAL FIELD

This disclosure relates to natural gas processing.

### BACKGROUND

Gas can be transported between locations via a pipe network. For example, natural gas is transported through pipelines at high pressure between the wellsite and downstream processing. However, natural gas that has been recovered from a hydrocarbon-bearing reservoir in a subterranean formation typically requires processing to remove components, such as water, prior to transporting through pipelines.

### SUMMARY

This disclosure describes technologies relating to natural gas processing, and in particular, natural gas processing that includes co-generation of electrical power. Certain aspects of the subject matter described can be implemented as a system for processing a natural gas stream comprising a hydrocarbon and water from a natural gas well. The system includes a flow-through electric generator, a throttle valve, a separator vessel, and an absorption tower. The flow-through electric generator includes a turbine wheel, a rotor, and a stator. The turbine wheel is configured to receive a first portion of the natural gas stream and rotate in response to expansion of the first portion of the natural gas stream flowing into an inlet of the turbine wheel and out of an outlet of the turbine wheel. The rotor is coupled to the turbine wheel and configured to rotate with the turbine wheel. The flow-through electric generator is configured to generate electrical power upon rotation of the rotor within the stator. The throttle valve defines an adjustable flow restriction configured to reduce a pressure of a second portion of the natural gas stream as the second portion of the natural gas stream flows through the throttle valve. The separator vessel is configured to receive the first portion of the natural gas stream from the flow-through electric generator and configured to separate phases of the first portion of the natural gas stream to produce at least a gaseous phase and an aqueous phase. The absorption tower is configured to receive the gaseous phase from the separator vessel and contact the gaseous phase with an absorbent configured to absorb water from the gaseous phase and produce a dehydrated natural gas stream.

This, and other aspects, can include one or more of the following features. In some implementations, a first outlet temperature of the first portion of the natural gas stream exiting the flow-through electric generator is less than a second outlet temperature of the second portion of the natural gas stream exiting the throttle valve. In some implementations, the system includes a controller communicatively coupled to the throttle valve and the flow-through electric generator. The controller can be configured to adjust a size of the adjustable flow restriction of the throttle valve, thereby adjusting torque applied to the flow-through electric generator. In some implementations, the natural gas stream includes oil, and the separator vessel is configured to separate phases of the first and second portions of the natural gas stream to produce the gaseous phase, the aqueous phase, and an oil phase. In some implementations, the absorption tower includes a plurality of trays. In some implementations, the absorbent is distributed across the plurality of trays. In some implementations, the absorption tower is configured to discharge the dehydrated natural gas stream and a wet absorbent stream. In some implementations, the system includes a second separator vessel configured to receive the second portion of the natural gas stream from the throttle valve and configured to separate phases of the second portion of the natural gas stream to produce at least a second gaseous phase and a second aqueous phase. In some implementations, the system includes a second absorption tower configured to receive the second gaseous phase from the second separator vessel and contact the second gaseous phase with a second absorbent configured to absorb water from the second gaseous phase to produce a second dehydrated natural gas stream. In some implementations, the second absorption tower includes a second plurality of trays. In some implementations, the second absorbent is distributed across the second plurality of trays. In some implementations, the second absorption tower is configured to discharge the second dehydrated natural gas stream and a second wet absorbent stream. In some implementations, the second separator vessel is smaller in size in comparison to the separator vessel, and the second plurality of trays of the second absorption tower has a larger number of trays in comparison to the plurality of trays of the absorption tower. In some implementations, the flow-through electric generator includes a hermetically sealed housing enclosing the turbine wheel. The rotor and the stator can be hermetically sealed inline in a flowline flowing the second portion of the natural gas stream, such that the second portion of the natural gas stream flows across the turbine wheel and the stator. In some implementations, the rotor includes a permanent magnet rotor.

Certain aspects of the subject matter described can be implemented as a method. A first portion of a natural gas stream is flowed from a natural gas well to a turbine wheel of a flow-through electric generator. The natural gas stream includes a hydrocarbon gas, a hydrocarbon liquid, and water. Electrical power is generated by the flow-through electric generator in response to the first portion of the natural gas stream flowing across the turbine wheel. A second portion of the natural gas stream is flowed through a throttle valve defining an adjustable flow restriction configured to reduce a pressure of the first portion of the natural gas stream as the second portion of the natural gas stream flows through the throttle valve. Phases of the first portion of the natural gas stream exiting the flow-through electric generator are separated to produce a first gaseous phase, a first aqueous phase, and a first oil phase. The first gaseous phase is contacted with a first absorbent to remove water from the first gaseous phase and produce a first dehydrated natural gas stream.

This, and other aspects, can include one or more of the following features. In some implementations, a size of the adjustable flow restriction of the throttle valve is adjusted, thereby adjusting torque applied to the flow-through electric generator. In some implementations, after flowing the second portion of the natural gas stream through the throttle valve, phases of the second portion of the natural gas stream are separated to produce a second gaseous phase, a second aqueous phase, and a second oil phase. In some implementations, the second gaseous phase is contacted with a second absorbent to remove water from the second gaseous phase and produce a second dehydrated natural gas stream. In some implementations, contacting the first gaseous phase with the first absorbent includes flowing the first absorbent across a first plurality of trays disposed in a first absorption tower. In some implementations, contacting the first gaseous phase with the first absorbent includes flowing the first gaseous phase across the first plurality of trays. The first absorbent and the first gaseous phase can flow through the first absorption tower in opposite directions. In some implementations, contacting the second gaseous phase with the second absorbent includes flowing the second absorbent across a second plurality of trays disposed in a second absorption tower. In some implementations, contacting the second gaseous phase with the second absorbent includes flowing the second gaseous phase across the second plurality of trays. The second absorbent and the second gaseous phase can flow through the second absorption tower in opposite directions. The second plurality of trays of the second absorption tower can have a larger number of trays in comparison to the first plurality of trays of the first absorption tower. In some implementations, the flow-through electric generator includes a stator, a rotor, and a hermetically sealed housing enclosing the turbine wheel. The stator and the rotor can be hermetically sealed inline in a flowline flowing the second portion of the natural gas stream, such that the second portion of the natural gas stream flows across the turbine wheel and the stator. In some implementations, the rotor includes a permanent magnet rotor.

Certain aspects of the subject matter described can be implemented as a system for processing a natural gas stream comprising a hydrocarbon and water from a natural gas well. This system includes a flow-through turboexpander generator, a throttle valve, a knockout separator, and an absorption separator. The flow-through turboexpander generator is configured to receive a first portion of the natural gas stream and generate electrical power in response to expansion of the first portion of the natural gas stream flowing through the flow-through turboexpander generator. The throttle valve is configured to reduce a pressure of a second portion of the natural gas stream as the second portion of the natural gas stream flows through the throttle valve. The knockout separator is configured to receive the first portion of the natural gas stream from the flow-through turboexpander generator and configured to separate phases of the first portion of the natural gas stream to produce at least a gaseous phase and an aqueous phase. The absorption separator is configured to receive the gaseous phase from the separator vessel and separate water from the gaseous phase to produce a dehydrated natural gas stream. This, and other aspects, can include one or more of the features mentioned in earlier paragraphs.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1 is a schematic diagram of an electrical power generation system including a turboexpander.

FIG. 2A is a schematic diagram of an example natural gas processing system that includes co-generation of electrical power by a turboexpander.

FIG. 2B is a schematic diagram of an example natural gas processing system that includes co-generation of electrical power by a turboexpander.

FIG. 3 is a flow chart of an example method for processing natural gas along with co-generation of electrical power.

### DETAILED DESCRIPTION

Natural gas recovered from hydrocarbon-bearing reservoirs in subterranean formations typically include additional components, such as formation water. Raw natural gas from such reservoirs is processed to remove some components, such as water and hydrogen sulfide, prior to transportation in pipelines. To process the natural gas, the natural gas is depressurized to lower levels (often using pressure regulators). The pressure is stepped down typically by using regulating valves to achieve the required pressure drop, but such valves can waste significant amounts of energy in the process. A turboexpander generator can be installed in parallel to the regulating valve to recover the wasted energy from pressure reduction and produce electrical power. By recovering lost energy from natural gas pressure letdown applications, the turboexpander can generate electricity while also reducing CO₂ emissions, increasing overall plant efficiency, offsetting electrical costs, and generating additional revenue.

The subject matter described in this disclosure can be implemented in particular implementations, so as to realize one or more of the following advantages. By including a turboexpander in parallel to a pressure letdown valve, useful electrical power can be generated from the gas expansion work involved in natural gas processing. The turboexpander can further decrease an operating temperature of the natural gas flowing through the turboexpander in comparison to a pressure letdown valve, which allows for additional water to condense and be separated from the natural gas. The additional water separation can allow for decreased equipment sizing, thereby reducing capital costs and expensive variable costs associated with operating downstream natural gas processing equipment. For example, inclusion of the turboexpander can allow for a smaller absorption tower, which in turn can reduce the amount of packing material necessary. Packing material in such absorption towers need to be replaced regularly, so using less packing material can save significant costs in the long run.

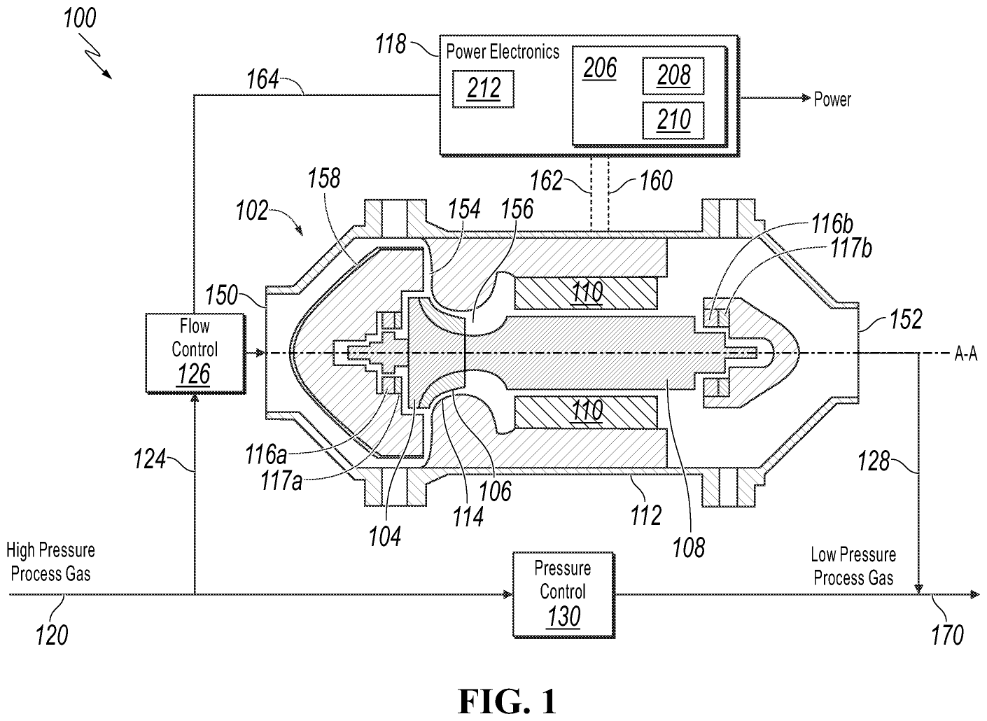

FIG. 1 is a schematic diagram of an electrical power generation system 100. The electrical power generation system 100 can be added at a pressure let down (PLD) station or at a natural gas processing facility to capture energy from gas expansion. The electrical power generation system 100 includes a turboexpander 102 in parallel with a pressure control valve 130.

The turboexpander 102 is arranged axially so that the turboexpander 102 can be mounted in-line with a pipe. The turboexpander 102 acts as an electric generator by generating electrical energy from rotational kinetic energy derived from expansion of a process gas 120 (e.g., natural gas flowing from a gas well) through a turbine wheel 104. For example, rotation of the turbine wheel 104 can be used to rotate a rotor 108 within a stator 110, which then generates electrical power.

The turboexpander 102 includes a high-performance, high-speed permanent magnet generator with an integrated radial in-flow expansion turbine wheel 104 and low loss active magnetic bearings (AMBs) 116a,b. The rotor assembly consists of the permanent magnet section with the turbine wheel 104 mounted directly to the rotor hub. The rotor 108 is levitated by the magnetic bearing system creating a frictionless (or near frictionless) interface between dynamic and static components. The AMBs 116a,b facilitate a lossless (or near lossless) rotation of the rotor 108.

The turboexpander 102 is designed to have the process gas 120 flow through the system 100, which cools the generator and eliminates the need for auxiliary cooling equipment. The power electronics 118 for the turboexpander 102 combines a power converter 206 and Magnetic Bearing Controller (MBC) 212 into one cabinet, in some implementations. The power converter 206 allows for consistent delivery of generated power from the turboexpander 102. For example, the power converter 206 regulates the frequency and voltage of the generated current to match a local power grid. As another example, the power converter 206 regulates the frequency and voltage of the generated current to be compatible for use by a power user. After expansion, the process gas 120 exits the turboexpander 102 along the same axial path for downstream processes.

The turboexpander 102 includes a flow-through configuration. The flow-through configuration permits the process gas 120 to flow from an inlet side of the turboexpander 102 to an outlet side of the turboexpander 102. The process gas 120 flows into a radial gas inlet 154 to the turbine wheel 104 and out of the turbine wheel 104 from an axial gas outlet 156. The process gas 120 then flow through the generator and out of the outlet 154, where the process gas 120 rejoins the gas pipeline 170. Generally, high pressure process gas 120 is directed to flow into the turboexpander 102 through a flow control system 126. The flow control system 126 includes a flow or mass control valve and an emergency shut off valve. Flow control system 126 can be controlled by power electronics 118 or other electrical, mechanical, or electromagnetic signal. For example, a fault condition can signal the flow control system 126 to close or partially close, thereby removing or restricting gas supply to the turboexpander 102. When the rotor 108 is operating at a constant speed, restricting or removing gas flow to the turboexpander 102 reduces the torque applied to the rotor 108 and, consequently, reduces the amount of current generated by the power converter 206. In the example shown in FIG. 1, a signal channel 164 from the power electronics 118 can be used to open and/or close the flow control system 126. In some implementations, the turboexpander housing 112 is hermetically sealed.

The process gas 120 is expanded by flowing across the turbine wheel 104, resulting in a pressure letdown of the process gas 120. The process gas 120 exits the turboexpander 102 at a decreased pressure. The expansion of the process gas 120 across the turbine wheel 104 causes the turbine wheel 104 to rotate, which causes the rotor 108 to rotate. The rotation of the rotor 108 within the stator 110 generates electrical power. The turboexpander 102 achieves the desired pressure letdown and captures the energy from the pressure letdown to generate electrical power. A pressure control valve 130, such as a conventional pressure regulator, can be installed in parallel to the turboexpander 102. Any excess high pressure process gas 120 that is not directed into the turboexpander 102 can be directed through the pressure control valve 130. For example, the pressure control valve 130 is configured to provide a constriction of an adjustable size for the portion of the process gas 120 flowing through the pressure control valve 130 to expand adiabatically across the pressure control valve 130. The pressure of the portion of the process gas 120 exiting the pressure control valve 130 equalizes with the pressure of the portion of the process gas 120 exiting the turboexpander 102. As such, the pressure control valve 130 and the flow control system 126 can work together to control the pressure of the process gas 120 that flows through the turboexpander and, in turn, control the amount of current generated by the power converter 206.

The turboexpander 102 includes a turbine wheel 104. The turbine wheel 104 is shown as a radial inflow turbine wheel, though other configurations are within the scope of this disclosure, such as axial flow turbine wheels. In this example, the process gas 120 is received from an inlet conduit 150 of the housing 112 enters a radially oriented inlet 154 of the turbine wheel 104. In some implementations, the process gas 120 flows through an inlet conduit 150 and is diverted by a flow diverter to a radial inlet 154 that directs the fluid into the radial inflow of the turbine wheel 104. After expanding, the process gas 120 exits the turbine wheel 104 from an axially oriented outlet 156 to outlet conduit 152 of the housing 112.

The turbine wheel 104 can be directly affixed to the rotor 108, or to an intermediate common shaft, for example, by fasteners, rigid drive shaft, welding, or other manner. For example, the turbine wheel 104 may be received at an end of the rotor 108, and held to the rotor 108 with a shaft. The shaft threads into the rotor 108 at one end, and at the other, captures the turbine wheel 104 between the end of rotor 108 and a nut threadingly received on the shaft. The turbine wheel 104 and rotor 108 can be coupled without a gearbox and rotate at the same speed. In other instances, the turbine wheel 104 can be indirectly coupled to the rotor 108, for example, by a gear train, clutch mechanism, or other manner.

The turbine wheel 104 includes a plurality of turbine wheel blades 106 extending outwardly from a hub and that interact with the expanding process gas 120 to cause the turbine wheel 104 to rotate. FIG. 1 shows an unshrouded turbine wheel 104, in which each of the turbine blades 106 has an exposed, generally radially oriented blade tip extending between the radial inlet 154 and axial outlet 156. As discussed in more detail below, the blade tips substantially seal against a shroud 114 on the interior of the housing 112. In certain instances, the turbine wheel 104 is a shrouded turbine wheel.

In configurations with an un-shrouded turbine wheel 104, the housing 112 includes an inwardly oriented shroud 114 that resides closely adjacent to, and at most times during operation, out of contact with the turbine wheel blades 106. The close proximity of the turbine wheel blades 106 and shroud 114 substantially seals against passage of process gas 120 therebetween, as the process gas 120 flows through the turbine wheel 104. Although some amount of the process gas 120 may leak or pass between the turbine wheel blades 106 and the shroud 114, the leakage is insubstantial in the operation of the turbine wheel 104. In certain instances, the leakage can be commensurate with other similar unshrouded-turbine/shroud-surface interfaces, using conventional tolerances between the turbine wheel blades 106 and the shroud 114. The amount of leakage that is considered acceptable leakage may be predetermined. The operational parameters of the turbine generator may be optimized to reduce the leakage. In some implementations, the housing 112 is hermetically sealed to prevent process gas 120 from escaping the radial inlet 154 of the turbine wheel 104.

The shroud 114 may reside at a specified distance away from the turbine wheel blades 106, and is maintained at a distance away from the turbine wheel blades 106 during operation of the turboexpander 102 by using magnetic positioning devices, including active magnetic bearings and position sensors.

Bearings 116a and 116b are arranged to rotatably support the rotor 108 and turbine wheel 104 relative to the stator 110 and the shroud 114. The turbine wheel 104 is supported in a cantilevered manner by the bearings 116a and 116b. In some implementations, the turbine wheel 104 may be supported in a non-cantilevered manner and bearings 116a and 116b may be located on the outlet side of turbine wheel 104. In certain instances, one or more of the bearings 116a or 116b can include ball bearings, needle bearings, magnetic bearings, foil bearings, journal bearings, or others.

Bearings 116a and 116b may be a combination radial and thrust bearing, supporting the rotor 108 in radial and axial directions. Other configurations could be utilized. The bearings 116a and 116b need not be the same types of bearings.

In implementations in which the bearings 116a and 116b are magnetic bearings, a magnetic bearing controller (MBC) 212 is used to control the magnetic bearings 116a and 116b. Position sensors 117a, 117b can be used to detect the position or changes in the position of the turbine wheel 104 and/or rotor 108 relative to the housing 112 or other reference point (such as a predetermined value). Position sensors 117a, 117b can detect axial and/or radial displacement. The magnetic bearing 116a and/or 116b can respond to the information from the position sensors 117a, 117b and adjust for the detected displacement, if necessary. The MBC 212 may receive information from the position sensor(s) 117a, 117b and process that information to provide control signals to the magnetic bearings 116a, 116b. MBC 212 can communicate with the various components of the turboexpander 102 across a communications channel 162.

The use of magnetic bearings 116a, 116b and position sensors 117a, 117b to maintain and/or adjust the position of the turbine wheel blades 106 such that the turbine wheel blades 106 stay in close proximity to the shroud 114 permits the turboexpander 102 to operate without the need for seals (e.g., without the need for dynamic seals). The use of the active magnetic bearings 116a,b in the turboexpander 102 eliminates physical contact between rotating and stationary components, as well as eliminate lubrication, lubrication systems, and seals.

The turboexpander 102 may include one or more backup bearings. For example, at start-up and shut-down or in the event of a power outage that affects the operation of the magnetic bearings 116a and 116b, bearings may be used to rotatably support the turbine wheel 104 during that period of time. The backup bearings and may include ball bearings, needle bearings, journal bearings, or the like.

As mentioned previously, the turboexpander 102 is configured to generate electrical power in response to the rotation of the rotor 108. In certain instances, the rotor 108 can include one or more permanent magnets. The stator 110 includes a plurality of conductive coils. Electrical power is generated by the rotation of the magnet within the coils of the stator 110. The rotor 108 and stator 110 can be configured as a synchronous, permanent magnet, multiphase alternating current (AC) generator. The electrical output 160 can be a three-phase output, for example. In certain instances, stator 110 may include a plurality of coils (e.g., three or six coils for a three-phase AC output). When the rotor 108 is rotated, a voltage is induced in the stator 110. At any instant, the magnitude of the voltage induced in stator coils is proportional to the rate at which the magnetic field encircled by the coil is changing with time (i.e., the rate at which the magnetic field is passing the two sides of the coil). In instances where the rotor 108 is coupled to rotate at the same speed as the turbine wheel 104, the turboexpander 102 is configured to generate electrical power at that speed. Such a turboexpander 102 is what is referred to as a “high speed” turbine generator. For example, the turboexpander 102 can produce up to 280 KW at a continuous speed of 30,000 rpm. In some implementations, the turboexpander produces on the order of 350 kW at higher rotational speeds (e.g., on the order of 35,000 rpm).

In some implementations, the design of the turbine wheel 104, rotor 108, and/or stator 110 can be based on a desired parameter of the output gas from the turboexpander 102. For example, the design of the rotor and stator can be based on a desired temperature of the process gas 120 exiting the turboexpander 102.

The turboexpander 102 can be coupled to a power electronics 118. Power electronics 118 can include a power converter 206 and the magnetic bearing controller (MBC) 212 (discussed above). The power converter 206 can be, for example, a variable speed drive (VSD) or a variable frequency drive.

The electrical output 160 of the turboexpander 102 is connected to the power converter 206, which can be programmed to specific power requirements. The power converter 206 can include an insulated-gate bipolar transistor (IGBT) rectifier 208 to convert the variable frequency, high voltage output from the turboexpander 102 to a direct current (DC). The rectifier 208 can be a three-phase rectifier for three-phase AC input current. An inverter 210 then converts the DC from the rectifier 208 to AC for supplying to the power grid 140. The inverter 210 can convert the DC to 380 VAC-480 VAC at 50 to 60 Hz for delivery to the power grid 140. The specific output of the power converter 206 depends on the power grid 140 and application. Other conversion values are within the scope of this disclosure. The power converter 206 matches its output to the power grid 140 by sampling the grid voltage and frequency, and then changing the output voltage and frequency of the inverter 210 to match the sampled power grid voltage and frequency.

In some implementations, the power converter 206 is a bidirectional power converter. In such implementations, the rectifier 208 can receive an alternating current from the power grid 140 and convert the alternating current into a direct current. The inverter 210 can then convert DC from the rectifier 208 to AC for supplying to the generator. In such implementations, power can be delivered from the power grid 140 to the generator to drive rotation of the rotor 108, and in turn, the turbine wheel 104 to induce flow of a process gas. In sum, in implementations in which the power converter 206 is a bidirectional power converter, the flow of power can be reversed and used by the generator to induce flow of a process gas (as opposed to the process gas contributing expansion work to generate power).

The turboexpander 102 is also connected to the MBC 212 in the power electronics 118. The MBC 212 constantly monitors position, current, temperature, and other parameters to ensure that the turboexpander 102 and the active magnetic bearings 116a and 116b are operating as desired. For example, the MBC 212 is coupled to position sensors 117a, 117b to monitor radial and axial position of the turbine wheel 104 and the rotor 108. The MBC 212 can control the magnetic bearings 116a, 116b to selectively change the stiffness and damping characteristics of the magnetic bearings 116a, 116b as a function of spin speed. The MBC 212 can also control synchronous cancellation, including automatic balancing control, adaptive vibration control, adaptive vibration rejection, and unbalance force rejection control.

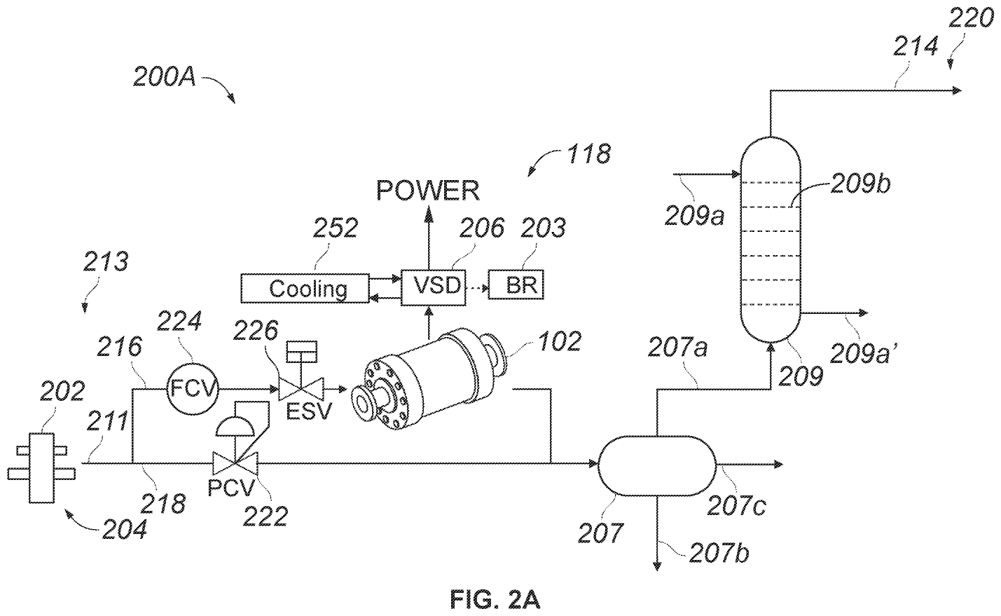

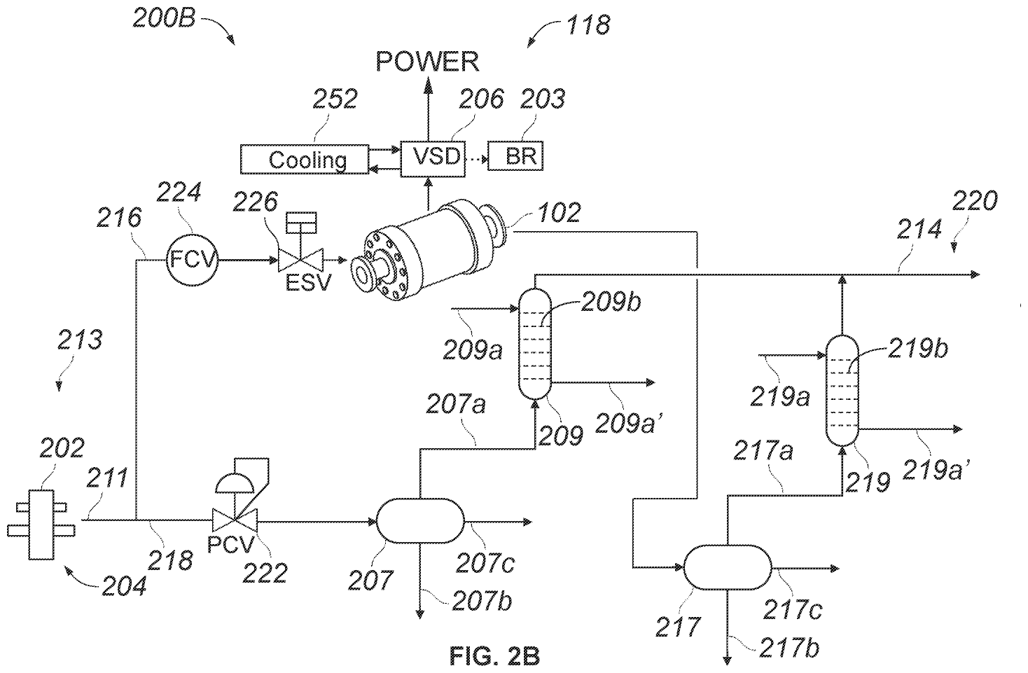

FIG. 2A is a schematic diagram of an example natural gas processing system 200A that includes co-generation of electrical power. The system 200A includes the turboexpander 102 and the power electronics 118 of system 100 (described previously and shown in FIG. 1), for recovering energy from reducing the pressure of the produced fluids from the well 204, as well as associated flow lines and other equipment. In certain instances, the system 200A resides at the production site 213, in proximity to the wellhead 202. In certain instances, the system 200A resides on or off the production site 213, upstream of the production pipeline 220. In one example of a land based well 204, the production site 213 is, and the system 200A resides on, the site with the other near well 204 equipment, upstream of the production pipeline 220. In another example, multiple land based wells 204 are on the same production site 213 feeding to the same pipeline 220, and the system 200A is coupled to one or more of the wells 204 and resides on the site 213. In one example of a subsea well 204, the production site 213 is, and system 200A resides on, a platform at the ocean surface. The platform can be a production platform corresponding to the well 204 (i.e., a subsea well), or it can be at a production platform associated with multiple of subsea wells 204, for example, where the wells 204 are manifolded to flow to a single production platform. In certain instances, the system 200A can reside on a dedicated platform apart from any production platform, and be coupled by a flow line to one or more other production platforms. In certain instances, the system 200A resides at a gas processing facility (e.g., a natural gas processing facility).

With reference to FIG. 2A, the system 200 includes, among other things of system 100, the above described turboexpander 102 in a hermetic housing 112, the electrical output of the generator of the turboexpander 102 being coupled to power electronics 118, including a VSD 206. In cases in which a brake resistor assembly 203 is included, the brake resistor assembly 203 is electrically connected to the electrical output of the turboexpander 102 (e.g., the output of the generator via the VSD 206). In some embodiments, the brake resistor assembly 203 and/or the contactor (electrically controlled switch for switching in an electrical power circuit) are not part of the power electronics, but are connected to the electrical output of the turboexpander 102 outside of the power electronics 118. Depending on the implementation choice, the contactor can be a normally closed (NC) contactor or a normally open (NO) contactor.

The turboexpander 102 can be configured to handle the gas conditions produced by the well 204, for example, configured to handle a specified amount of liquid in the gas, particulate in the gas, as well as to be resistant to corrosive aspects (e.g., hydrogen sulfide) in the gas. In certain instances, the VSD 206 can be coupled to a cooling system 252 to cool the electronics of the VSD 206 to maintain temperatures below a specified operating temperature. The output of the VSD 206 can be electrically coupled to a load, such as a power grid to supply power to the grid, as described above, a microgrid at the production site 213 for supplying power to equipment used for producing or treating gas at the production site 213, and/or directly to one or more pieces of equipment used for producing or treating gas at the production site 213 to supply power to the equipment. In certain instances, the equipment includes flow, pressure, temperature, and level sensors of various equipment, valve actuators, communications equipment for allowing remote communication with the sensors, other equipment and control of the valve actuators, separators (e.g., sand separators, liquid separators), heater treaters, site lighting, control trailers and/or other types of equipment. In certain instances, the electricity produced by the system 200 can be used by other equipment at the production site 213 not involved in producing or treating the gas from the well 204.

The system 200A includes a flow line 211 flowing production fluid (such as natural gas) from the well 204. Well production, that is primarily gaseous natural gas (but often also has some oil, water, moisture, condensate, and particulate), flows from the wellhead 202, and flows through flow line 211. The flow line 211 includes flow conditioning equipment to condition the flow to specified conditions selected based on the specification of pipeline 220 and equipment downstream of the production site 213. In FIG. 2A, the conditioning equipment is shown as a separator 207 and an absorption tower 209, but the conditioning equipment could include additional, different or fewer pieces and types of equipment. For example, the conditioning equipment can include separators, molecular driers, knock-out drums, two-phase coalescers and/or other types of conditioning equipment. Turning back to the specific example of FIG. 2A, flow in flow line 211 flows from the wellhead 202 to and through the separator 207. In the separator 207, solids and liquids are separated from the gaseous flow. Thereafter, the flow flows through the flow line 211 to the absorption tower 209, where the natural gas is dehydrated to reduce moisture in the flow to a specified level selected (in part or entirely) based on the specification of the pipeline 220 and/or equipment downstream of the production site 213. Each of the valves of the system 200A, whether control or isolation or other, can be remote controlled, e.g., via an operator at a remote control board on the production site 213 or elsewhere or both, and/or autonomously controlled by a control algorithm of a controller residing at the production site 213 or elsewhere or both.

Flow line 211, from the well 204, is split into a first downstream flow line 216 that includes a turboexpander 102, and a second downstream flow line 218 that bypasses the turboexpander 102. The first downstream flow line 216 and second downstream flow line 218 recombine upstream of the production pipeline 220, again into flow line 211, before leaving the production site 213. The inlet of the hermetic housing 112 is hermetically coupled in-line with first flow line 216 so that all fluid in the flow line 216 is directed into the hermetic housing 112, flows through the housing 112, and back into the remainder of first flow line 216.

The second flow line 218 includes a pressure control valve 222 (like pressure control valve 130) configured with a specified pressure drop to actuation position correlation. The pressure control valve 222 is a throttle valve that defines an adjustable flow restriction configured to reduce a pressure of the portion of the natural gas flowing through the second flow line 218. In some implementations, the pressure control valve 222 is a Joule-Thomson valve. As the natural gas flowing through the pressure control valve 222 expands (reduces in pressure), the operating temperature of the natural gas flowing through the pressure control valve 222 can decrease due to the Joule-Thomson effect. The pressure control valve 222 can be controlled to regulate the pressure in the second flow line 218 downstream of the valve 222, and in turn (as a function of the pressure of the flow coming from the well) the pressure upstream of the pressure control valve 222 and the pressure in the first flow line 216. The first flow line 216 includes a flow control valve 224 (like flow control valve 126), configured with a specified flow rate to actuation position correlation. The flow control valve 224 can be controlled in relation to the pressure control valves 222 to control the flow rate of fluid flowing through the first flow line 216, and thus the flow rate of flowing through the turboexpander 102.

This arrangement provides the turboexpander 102 in parallel to the second flow line 218, and as will be discussed in more detail below, allows freedom in sizing the turboexpander 102 relative to the pressure and flow rate of flow produced from the well 204 as well as relative to the conditions of the pipeline 220. The freedom stems, in part, from the second flow line 218 allowing flow to selectively bypass the turboexpander 102 in flowing from the wellhead 202 to the production pipeline 220. All flow need not pass through the turboexpander 102 in flowing from the wellhead 202 to the pipeline 220, so the turboexpander 102 need not be sized to receive all of the flow. The first flow line 216 also includes an emergency shut-off valve 226 upstream of the turboexpander 102 to quickly shut off flow to the turboexpander 102, if needed. When closed, the entirety of the flow flows through the second flow line 218. Notably, although not shown, the inlet flow line 211, first flow line 216 and second flow line 218 can additionally be instrumented with sensors to monitor the pressure, temperature, flow rate, and/or other characteristics of the flow in each line and upstream and/or downstream of each component (e.g., valves, turboexpander and other components in the flow lines).

In operation, when the well 204 is new and first put on production, the fluids produced from the well 204 are at or near their highest pressure and flow rate. Over time, the pressure of the produced fluids declines, as does the flow rate of the produced fluids. The pressure control valve 222 in the second flow line 218 is controlled to maintain the pressure through the first flow line 216 and through the turboexpander 102 so that together with the flow control valve 224 the conditions through the turboexpander 102 are maintained within the turboexpander's specified operating range. Excess flow exits the second flow line 218 and is directed to the flow line 211. The flow through the first flow line 216 flows through the turboexpander 102, generating power, and then back to recombine with the flow from the second flow line 218 and on to the flow line 211.

The characteristics of the turboexpander 102 are selected based on a number of factors, including the expected pressures, temperatures and flow rates that can be maintained by the well 204 over time, the timeframe during the life of the well 204 that power generated by the turboexpander 102 is desired or needed (e.g., whether the power is needed at the outset of the well's life, over as much of the well's life as is feasible, or only at the tail of the well's life), the ambient conditions at the production site 213, the efficiency/performance of the solids and liquids separator 207 and dryer 209, the conditions, including pressure, temperature and/or flow rate, specified for receipt by the pipeline 220 (often specified by the pipeline operator), and the amount of electricity desired or needed to be produced at the production site 213 by the turboexpander 102. The specified pressure to which the pressure control valve 222 is controlled can be selected based on a number of factors, including the pressure, temperature and flow characteristics of the turboexpander 102, the amount of electricity desired or needed to be produced, as well as the pressure, temperature and/or flow rate, specified for receipt by the pipeline 220. For example, in certain instances, the pipeline 220 is configured to operate at a specified pressure. The turboexpander 102, which causes a pressure drop as it extracts energy from the flow, is configured to, in cooperation with the pressure control valve 222 produce an outlet pressure out of the turboexpander 102 is sufficient for the natural gas to reach the pipeline 220 at the specified pressure of the pipeline 220. In certain instances, the pipeline 220 also has a specified minimum temperature, for example a temperature selected to prevent freezing of the fluids in the pipeline. The turboexpander 102, which causes a temperature drop as it extracts energy from the flow, is configured to, in cooperation with the pressure control valve 222 (which also causes a temperature drop), maintain an outlet temperature of the turboexpander 102 and at the entrance to the pipeline 220 at the specified pressure at or above the specified minimum temperature. Providing a numerical example, in certain instances, the pressure of the well can be initially 9,000 PSIG (62.05MPa) or higher and the flow is regulated down to 1,600 PSIG (11.03 MPa) using the pressure control valve 222. As the well 204 ages, and the pressure declines, this 1,600 PSIG (11.03 MPa) can be maintained until the well's pressure drops below 1,600 PSIG (11.03 MPa). While the well is above 1,600 PSIG (11.03 MPa), the turboexpander 102, which can be optimized to operate at peak efficiency under the pressure, temperature and flow conditions offered by the well 204 during this time, operates to generate electricity, while also providing and maintaining a further pressure drop downstream of the turboexpander 102 to the specified pressure of the pipeline 220. The hotter the well, the more energy is available for the turboexpander 102 to extract. As the well 204 pressure drops below 1,600 PSIG (11.03 MPa), the efficiency of the turboexpander 102 drops off until the well conditions can no longer operate the turboexpander 102 sufficiently. Thereafter, the first flow line 216 is shut off and flow is directed through only the second flow line 218, so that the turboexpander 102 does not provide an additional pressure drop. In certain instances, the turboexpander 102 is configured to produce usable amounts of electricity until the pressure upstream approaches the pipeline's specified pressure. Often times, this specified pressure is about 1,000 PSIG (6.89 MPa).

The turboexpander 102 can cause a temperature drop that is greater than the temperature drop caused by the pressure control valve 222, such that an outlet temperature of the natural gas exiting the turboexpander 102 is less than (cooler than) an outlet temperature of the natural gas exiting the pressure control valve 222. In some cases, the turboexpander 102 is specifically designed to cause a larger temperature drop in the natural gas relative to the pressure control valve 222. In some implementations, the turboexpander 102 is configured to discharge the natural gas at an outlet temperature that is less than (cooler than) a dewpoint of the natural gas. In some implementations, the pressure control valve 222 is sized to expand the natural gas and discharge the natural gas at an outlet temperature that is less than (cooler than) a dewpoint of the natural gas, and the turboexpander 102 is configured to discharge the natural gas at a second outlet temperature that is less than (cooler than) the outlet temperature of the natural gas exiting the pressure control valve 222. In some implementations, the turboexpander 102 is sized to operate independently (of the pressure control valve 222) for a majority (or all of) the operating life of the well 204. In some implementations, the system 200A is designed to split the flow of natural gas from the well 204 between the turboexpander 102 and the pressure control valve 222, such that the natural gas exiting the turboexpander 102 and pressure control valve 222 is at an operating temperature that is less than (cooler than) the dewpoint of the natural gas, less than (cooler than) an operating temperature of natural gas that only flows through a pressure control valve (as opposed to also at least partially flowing through the turboexpander 102), or both.

The natural gas expands as it flows through the turboexpander 102, which causes the turbine wheel 104 to rotate. The rotation of the turbine wheel 104 rotates the rotor 108 that supports a plurality of permanent magnets. The rotation of the permanent magnets on the rotor 108 induces a current through coils or windings on stator 110 to produce electrical power. In some embodiments, as shown in FIG. 2A, the power electronics 118 is configured to provide consistent delivery of generated power from the turboexpander 102 to a power grid and/or another user.

The separator 207 is a separator vessel that is configured to receive the natural gas that has rejoined downstream of the turboexpander 102 and the pressure control valve 222. The separator 207 is configured to separate phases of the natural gas to produce at least a gaseous phase 207a and an aqueous phase 207b. The separator 207 can be, for example, a free-water knockout vessel. In implementations in which the natural gas produced by the well 204 includes hydrocarbon gas(es), hydrocarbon liquid(s), and water, the separator 207 is configured to separate phases of the natural gas to produce the gaseous phase 207a, the aqueous phase 207b, and an oil phase 207c. The separator 207 is sized to have a holding volume sufficient to allow separation of phases of the natural gas received by the separator 207. In other words, the separator 207 is sized to have a sufficient volume, such that the residence time of the natural gas received by the separator 207 is sufficiently long for the flow of the natural gas to slow down within the separator 207 and allow for heavier components to drop out and separate from lighter components of the natural gas. In some cases, the separator 207 includes a weir that can facilitate separation of the oil phase 207c from the aqueous phase 207b. Because the oil phase 207c is less dense in comparison to the aqueous phase 207b, the oil phase 207c will pass over the top of the weir to the other side of the weir while the aqueous phase 207b remains separated on the opposite side of the weir. The weir can be sized (for example, have a height within the separator 207) to be taller than the expected liquid level of the aqueous phase 207b in the separator 207. The aqueous phase 207b can be drained from the separator 207 at a rate that ensures that the liquid level of the aqueous phase 207b in the separator 207 remains below the top of the weir while still allowing for the oil phase 207c to pass over the top of the weir. The aqueous phase 207b exiting the separator 207 can, for example, be further processed to remove contaminants (such as salts) and/or be injected back into a subterranean formation. The oil phase 207c exiting the separator 207 can, for example, be further processed to remove contaminants (such as water) to produce an oil stream. As mentioned previously, inclusion of the turboexpander 102 allows for at least a portion of the natural gas (the portion that flows through the turboexpander 102) to have an operating temperature less than (cooler than) a dewpoint of the natural gas, less than (cooler than) an operating temperature of the natural gas exiting the pressure control valve 222, or both. The lower operating temperature of the natural gas exiting the turboexpander 102 causes additional water to drop out of the natural gas in the separator 207. In such cases, the separator 207 may be sized to be larger than a separator that receives natural gas only from a pressure control valve.

The absorption tower 209 is a vessel that is configured to receive the gaseous phase 207a from the separator 207. The absorption tower 209 is configured to contact the gaseous phase 207a with a absorbent 209a to absorb water from the gaseous phase 207a and produce a dehydrated natural gas stream 214. The dehydrated natural gas stream 214 is a remainder of the gaseous phase 207a after the water has been removed by the absorption tower 209. The dehydrated natural gas stream 214 exiting the absorption tower 209 is a sales gas that can be transported, for example, to an end user or a distribution network via the pipeline 220. The dehydrated natural gas stream 214 has a specified water content. In certain instances, the specified water content of the dehydrated natural gas stream 214 is based on specifications identified by the industry and/or downstream recipients/users of the dehydrated natural gas stream 214. In some implementations, the dehydrated natural gas stream 214 has a water content in a range of from 0 pounds per million standard cubic feet (MMSCF) to about 7 pounds per MMSCF.

As mentioned previously, inclusion of the turboexpander 102 can allow for more water to drop out of the natural gas in the separator 207 in comparison to systems that include only a pressure control valve and not the turboexpander 102. Thus, inclusion of the turboexpander 102 can allow for the absorption tower 209 to be sized smaller than an absorption tower that is downstream from a separator that receives natural gas only from a pressure control valve. The pressure control valve 222, turboexpander 102, separator 207, and absorption tower 209 can therefore be sized relative to one another to achieve production of the dehydrated natural gas stream 214 with a specified water content. Inclusion of the turboexpander 102 allows for a decreased (cooler) operating temperature of the natural gas, which in turn causes additional water to drop out from the natural gas, thereby affecting the size of downstream equipment. The separator 207 can be sized to be larger to accommodate the larger volume of water to separate from the natural gas, and the absorption tower 209 can be sized to be smaller because a larger portion of the water originally in the natural gas has already been separated from the natural gas by the upstream separator 207. In effect, inclusion of the turboexpander 102 can improve water separation efficiency of the system 200A.

The gaseous phase 207a and the absorbent 209a can flow across the absorption tower 209 in opposite directions and across each other to improve contact between the gaseous phase 207a and the absorbent 209a. In some implementations, the absorption tower 209 includes trays 209b (such as bubble cap trays) distributed along a height of the absorption tower 209. In some implementations, the absorption tower 209 includes structured packing distributed along a height of the absorption tower 209. In some implementations, the absorption tower 209 includes random packing distributed along a height of the absorption tower 209. In some implementations, the absorbent 209a is distributed across the trays 209b, structured packing, and/or random packing. The inclusion of trays 209b, structured packing, and/or random packing in the absorption tower 209 can further facilitate contact between the absorbent 209a and the gaseous phase 207a within the absorption tower 209 by providing a greater contact area between the absorbent 209a and the gaseous phase 207a. For sufficient absorption, the packing material (whether structured or random) should have enough room for the liquid (absorbent 209a) to flow through without causing excessive pressure drop, while also allowing for sufficient contact between the liquid (absorbent 209a) and the gas (gaseous phase 207a). Structured packing uses fixed packing structures which channel the liquid (absorbent 209a) into a specific shape. Structured packing material contains holes, grooves, corrugation, textured elements, or any combinations of these that allow for increased surface area. Some non-limiting examples of structured packing include gauze packing and sheet metal packing. Random packing includes individual pieces of material that fill a portion of the absorption tower 209. Some non-limiting examples of random packing include ceramic saddles and stainless steel pall rings.

In some implementations, the absorbent 209a flows into the absorption tower 209 near the top of the absorption tower 209, flows down the absorption tower 209 across the trays 209b, and exits the bottom of the absorption tower 209. In some implementations, the gaseous phase 207a flows into the absorption tower 209 near the bottom of the absorption tower 209, flows up the absorption tower 209 across the trays 209b, and exits the top of the absorption tower 209. As the gaseous phase 207a and the absorbent 209a flow in opposite directions and across each other within the absorption tower 209, the gaseous phase 207a and the absorbent 209a comes into contact with each other. The absorbent 209a, having an affinity for water, absorbs water from the gaseous phase 207a. Thus, there is a mass transfer of water from the gaseous phase 207a to the absorbent 209a within the absorption tower 209. The absorbent 209a′ exiting the absorption tower 209 is wet. In some implementations, the absorbent 209a′ is processed to remove the absorbed water, so that the absorbent 209a is regenerated and can be recycled back to the absorption tower 209. In some implementations, the absorbent 209a is an ethylene glycol, such as triethylene glycol (TEG), diethylene glycol, or monoethylene glycol.

FIG. 2B is a schematic diagram of an example natural gas processing system 200B that includes co-generation of electrical power. The system 200B is substantially similar to the system 200A of FIG. 2A, except as noted below. In addition to the components described with respect to system 200A, the system 200B also includes a second separator 217 and a second absorption tower 219. Instead of combining the first portion of the natural gas exiting the turboexpander 102 in the first flow line 216 and the second portion of the natural gas exiting the pressure control valve 222 in the second flow line 218, the first portion of the natural gas exiting the turboexpander 102 in the first flow line 216 flows to the first separator 207, and the second portion of the natural gas exiting the pressure control valve 222 in the second flow line 218 flows to the second separator 217 in the implementation shown in FIG. 2B. In some implementations, the first portion of the natural gas exiting the turboexpander 102 in the first flow line 216 flows to the second separator 217, and the second portion of the natural gas exiting the pressure control valve 222 in the second flow line 218 flows to the first separator 207.

The second separator 217 is substantially similar to the first separator 207. For example, the second separator 217 can include the same components as the first separator 207. In contrast, the second separator 217 may have a different size, different dimensions, different spacing between components (for example, different spacing for the weir), or any combinations of these in comparison to the first separator 207. The second separator 217 is configured to separate phases of the second portion of the natural gas to produce at least a second gaseous phase 217a and a second aqueous phase 217b. In implementations in which the natural gas produced by the well 204 includes hydrocarbon gas(es), hydrocarbon liquid(s), and water, the second separator 217 is configured to separate phases of the natural gas to produce the second gaseous phase 217a, the second aqueous phase 217b, and a second oil phase 217c. The second separator 217 is sized to have a holding volume sufficient to allow separation of phases of the natural gas received by the second separator 217. In some cases, the second separator 217 includes a weir that can facilitate separation of the second oil phase 217c from the aqueous phase 217b. Because the second oil phase 217c is less dense in comparison to the second aqueous phase 217b, the second oil phase 217c will pass over the top of the weir to the other side of the weir while the second aqueous phase 217b remains separated on the opposite side of the weir. The weir can be sized (for example, have a height within the second separator 217) to be taller than the expected liquid level of the second aqueous phase 217b in the second separator 217. The second aqueous phase 217b can be drained from the second separator 217 at a rate that ensures that the liquid level of the second aqueous phase 217b in the second separator 217 remains below the top of the weir while still allowing for the second oil phase 217c to pass over the top of the weir. The second aqueous phase 217b exiting the second separator 217 can, for example, be further processed to remove contaminants (such as salts) and/or be injected back into a subterranean formation. The second oil phase 217c exiting the second separator 217 can, for example, be further processed to remove contaminants (such as water) to produce a natural gas liquids stream.

In implementations in which the second separator 217 receives the portion of the natural gas exiting the turboexpander 102 and the first separator 207 receives the portion of the natural gas exiting the pressure control valve 222, the first separator 207 can be smaller in size in comparison to the second separator 217. In such implementations, the portion of the natural gas exiting the turboexpander 102 can have an operating temperature that is less than the operating temperature of the portion of the natural gas exiting the pressure control valve 222, even if the natural gas exiting the turboexpander 102 and the natural gas exiting the pressure control valve 222 have the same operating pressure. In such cases, the lower operating temperature of the natural gas exiting the turboexpander 102 can cause additional water to condense from the natural gas in comparison to the natural gas exiting the pressure control valve 222. The larger size of the second separator 217 in such cases can be beneficial for accounting for the additional volume of water expected to separate from the natural gas in the second separator 217 in comparison to the first separator 207.

The second absorption tower 219 is substantially similar to the first absorption tower 209. For example, the second absorption tower 219 can include the same components as the first absorption tower 209. In contrast, the second absorption tower 219 may have a different size, different dimensions, different spacing between components (for example, different spacing between trays), or any combinations of these in comparison to the first absorption tower 209. The second absorption tower 219 is a vessel that is configured to receive the second gaseous phase 217a from the second separator 217. The second absorption tower 219 is configured to contact the second gaseous phase 217a with a second absorbent 219a to absorb water from the second gaseous phase 217a and produce a second dehydrated natural gas stream 215. The second dehydrated natural gas stream 215 is a remainder of the second gaseous phase 217a after the water has been removed by the second absorption tower 219. The dehydrated natural gas stream 215 exiting the second absorption tower 219 is a sales gas that can be transported, for example, to an end user or a distribution network via the pipeline 220. The dehydrated natural gas stream 215 has a specified water content. In certain instances, the specified water content of the dehydrated natural gas stream 215 is based on specifications identified by the industry and/or downstream recipients/users of the dehydrated natural gas stream 215. In some implementations, the dehydrated natural gas stream 215 has a water content in a range of from 0 pounds per MMSCF to about 7 pounds per MMSCF.

The second gaseous phase 217a and the second absorbent 219a can flow across the second absorption tower 219 in opposite directions and across each other to improve contact between the second gaseous phase 217a and the second absorbent 219a. In some implementations, the second absorption tower 219 includes trays 219b (such as bubble cap trays) distributed along a height of the second absorption tower 219. In some implementations, the second absorption tower 219 includes structured packing distributed along a height of the second absorption tower 219. In some implementations, the second absorption tower 219 includes random packing distributed along a height of the second absorption tower 219. In some implementations, the second absorbent 219a is distributed across the trays 219b, structured packing, and/or random packing. The inclusion of trays 219b, structured packing, and/or random packing in the second absorption tower 219 can further facilitate contact between the second absorbent 219a and the second gaseous phase 217a within the second absorption tower 219 by providing a greater contact area between the second absorbent 219a and the second gaseous phase 217a. For sufficient absorption, the packing material (whether structured or random) should have enough room for the liquid (second absorbent 219a) to flow through without causing excessive pressure drop, while also allowing for sufficient contact between the liquid (second absorbent 219a) and the gas (second gaseous phase 217a). Structured packing uses fixed packing structures which channel the liquid (second absorbent 219a) into a specific shape. Structured packing material contains holes, grooves, corrugation, textured elements, or any combinations of these that allow for increased surface area. Some non-limiting examples of structured packing include gauze packing and sheet metal packing. Random packing includes individual pieces of material that fill a portion of the second absorption tower 219. Some non-limiting examples of random packing include ceramic saddles and stainless steel pall rings.

In some implementations, the second absorbent 219a flows into the second absorption tower 219 near the top of the second absorption tower 219, flows down the second absorption tower 219 across the trays 219b, and exits the bottom of the second absorption tower 219. In some implementations, the second gaseous phase 217a flows into the second absorption tower 219 near the bottom of the second absorption tower 219, flows up the second absorption tower 219 across the trays 219b, and exits the top of the second absorption tower 219. As the second gaseous phase 217a and the second absorbent 219a flow in opposite directions and across each other within the second absorption tower 219, the second gaseous phase 217a and the second absorbent 219a comes into contact with each other. The second absorbent 219a, having an affinity for water, absorbs water from the second gaseous phase 217a. Thus, there is a mass transfer of water from the second gaseous phase 217a to the second absorbent 219a within the second absorption tower 219. The second absorbent 219a′ exiting the second absorption tower 219 is wet. In some implementations, the second absorbent 219a′ is processed to remove the absorbed water, so that the second absorbent 219a is regenerated and can be recycled back to the second absorption tower 219. In some implementations, the second absorbent 219a is an ethylene glycol, such as triethylene glycol (TEG), diethylene glycol, or monoethylene glycol.

In implementations in which the second separator 217 receives the portion of the natural gas exiting the turboexpander 102 and the first separator 207 receives the portion of the natural gas exiting the pressure control valve 222, the first absorption tower 209 can include additional trays 209b, additional random packing, additional structured packing, or any combinations of these in comparison to the second absorption tower 219. As described previously, more water can condense from the portion of natural gas exiting the turboexpander 102 due to its lower operating temperature in comparison to the portion of the natural gas exiting the pressure control valve 222. As such, more water can remain in the gaseous phase 207a exiting the first separator 207 and entering the first absorption tower 209 in comparison to the second gaseous phase 217a exiting the second separator 217 and entering the second absorption tower 219. Due to the greater water content of the gaseous phase 207a in comparison to the second gaseous phase 217a, the first absorption tower 207 can require additional surface area (by inclusion of additional trays 209b, additional random packing, additional structured packing, or any combinations of these) for contact between the gaseous phase 207a and the absorbent 209a to meet the target specifications (such as water content) of the dehydrated natural gas stream 214 exiting the first absorption tower 207.

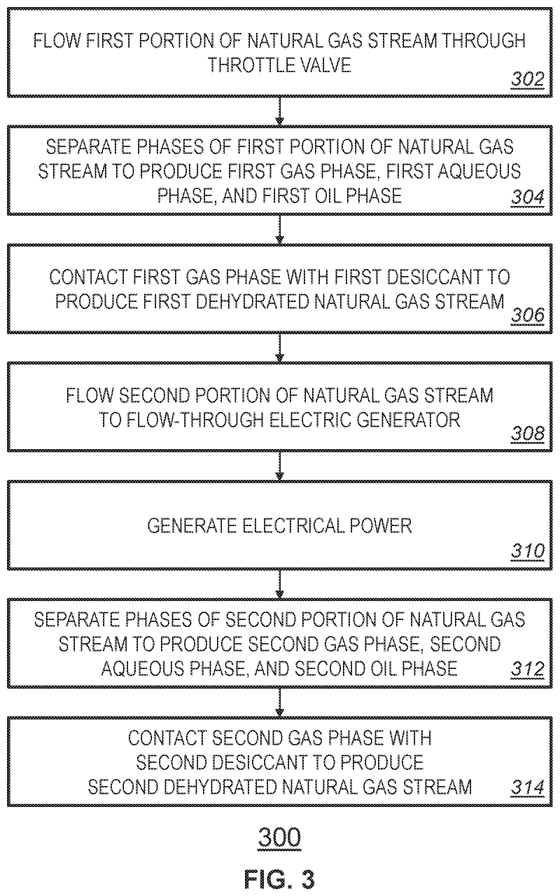

FIG. 3 is a flow chart of an example method 300 for processing natural gas along with co-generation of electrical power. Any of the systems 200A or 200B, for example, can implement the method 300. At block 302, a first portion of a natural gas stream (such as a first portion of the natural gas from well 204) is flowed through a throttle valve (such as the pressure control valve 222) to reduce a pressure of the first portion of the natural gas stream. After flowing the first portion of the natural gas stream through the throttle valve at block 302, phases of the first portion of the natural gas stream are separated at block 304 to produce a first gaseous phase (such as the first gaseous phase 207a), a first aqueous phase (such as the first aqueous phase 207b), and a first oil phase (such as the first oil phase 207c). Separating the phases of the first portion of the natural gas stream at block 304 can be performed, for example, by the first separator 207. At block 306, the first gaseous phase 207a is contacted with a first absorbent (such as the first absorbent 209a) to remove water from the first gaseous phase 207a and produce a first dehydrated natural gas stream (such as the dehydrated natural gas stream 214). Contacting the first gaseous phase 207a with the first absorbent 209a at block 306 can be performed, for example, by the first absorption tower 209. At block 308, a second portion of the natural gas stream is flowed to a turbine wheel (such as the turbine wheel 104) of a flow-through electric generator (such as the turboexpander 102). At block 310, electrical power is generated by the flow-through generator (turboexpander 102) in response to the second portion of the natural gas stream flowing across the turbine wheel 104. At block 312, phases of the second portion of the natural gas stream exiting the flow-through electric generator (turboexpander 102) are separated to produce a second gaseous phase (such as the second gaseous phase 217a), a second aqueous phase (such as the second aqueous phase 217b), and a second oil phase (such as the second oil phase 217c). Separating the phases of the second portion of the natural gas stream at block 312 can be performed, for example, by the second separator 217. At block 314, the second gaseous phase 217a is contacted with a second absorbent (such as the second absorbent 219a) to remove water from the second gaseous phase 217a and produce a second dehydrated natural gas stream (such as the second dehydrated natural gas stream 215). Contacting the second gaseous phase 217a with the second absorbent 219a at block 314 can be performed, for example, by the second absorption tower 219.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A system for processing a natural gas stream comprising a hydrocarbon and water from a natural gas well, the system comprising:
a flow-through electric generator comprising:
a turbine wheel configured to receive a first portion of the natural gas stream and rotate in response to expansion of the first portion of the natural gas stream flowing into an inlet of the turbine wheel and out of an outlet of the turbine wheel;
a rotor coupled to the turbine wheel and configured to rotate with the turbine wheel; and
a stator, wherein the flow-through electric generator is configured to generate electrical power upon rotation of the rotor within the stator;
a throttle valve defining an adjustable flow restriction configured to reduce a pressure of a second portion of the natural gas stream as the second portion of the natural gas stream flows through the throttle valve;
a separator vessel configured to receive the first portion of the natural gas stream from the flow-through electric generator and configured to separate phases of the first portion of the natural gas stream to produce at least a gaseous phase and an aqueous phase; and
an absorption tower configured to receive the gaseous phase from the separator vessel and contact the gaseous phase with an absorbent configured to absorb water from the gaseous phase and produce a dehydrated natural gas stream.

2. The system of claim 1, wherein a first outlet temperature of the first portion of the natural gas stream exiting the flow-through electric generator is less than a second outlet temperature of the second portion of the natural gas stream exiting the throttle valve.

3. The system of claim 2, further comprising a controller communicatively coupled to the throttle valve and the flow-through electric generator, wherein the controller is configured to adjust a size of the adjustable flow restriction of the throttle valve, thereby adjusting torque applied to the flow-through electric generator.

4. The system of claim 3, wherein the natural gas stream further comprises oil, and the separator vessel is configured to separate phases of the first and second portions of the natural gas stream to produce the gaseous phase, the aqueous phase, and an oil phase.

5. The system of claim 4, wherein the absorption tower comprises a plurality of trays, the absorbent is distributed across the plurality of trays, and the absorption tower is configured to discharge the dehydrated natural gas stream and a wet absorbent stream.

6. The system of claim 5, further comprising a second separator vessel configured to receive the second portion of the natural gas stream from the throttle valve and configured to separate phases of the second portion of the natural gas stream to produce at least a second gaseous phase and a second aqueous phase.

7. The system of claim 6, further comprising a second absorption tower configured to receive the second gaseous phase from the second separator vessel and contact the second gaseous phase with a second absorbent configured to absorb water from the second gaseous phase to produce a second dehydrated natural gas stream.

8. The system of claim 7, wherein the second absorption tower comprises a second plurality of trays, the second absorbent is distributed across the second plurality of trays, and the second absorption tower is configured to discharge the second dehydrated natural gas stream and a second wet absorbent stream.

9. The system of claim 8, wherein the second separator vessel is smaller in size in comparison to the separator vessel, and the second plurality of trays of the second absorption tower has a larger number of trays in comparison to the plurality of trays of the absorption tower.

10. The system of claim 9, wherein the flow-through electric generator comprises a hermetically sealed housing enclosing the turbine wheel, wherein the rotor and the stator are hermetically sealed inline in a flowline flowing the second portion of the natural gas stream, such that the second portion of the natural gas stream flows across the turbine wheel and the stator.

11. The system of claim 10, wherein the rotor comprises a permanent magnet rotor.

12. A method comprising:
flowing a first portion of a natural gas stream, from a natural gas well, to a turbine wheel of a flow-through electric generator, wherein the natural gas stream comprises a hydrocarbon gas, a hydrocarbon liquid, and water;
generating electrical power by the flow-through electric generator in response to the first portion of the natural gas stream flowing across the turbine wheel;
flowing a second portion of the natural gas stream through a throttle valve defining an adjustable flow restriction configured to reduce a pressure of the first portion of the natural gas stream as the second portion of the natural gas stream flows through the throttle valve;
separating phases of the first portion of the natural gas stream exiting the flow-through electric generator to produce a first gaseous phase, a first aqueous phase, and a first oil phase; and
contacting the first gaseous phase with a first absorbent to remove water from the first gaseous phase and produce a first dehydrated natural gas stream.

13. The method of claim 12, further comprising adjusting a size of the adjustable flow restriction of the throttle valve, thereby adjusting torque applied to the flow-through electric generator.

14. The method of claim 13, further comprising, after flowing the second portion of the natural gas stream through the throttle valve, separating phases of the second portion of the natural gas stream to produce a second gaseous phase, a second aqueous phase, and a second oil phase.

15. The method of claim 14, further comprising contacting the second gaseous phase with a second absorbent to remove water from the second gaseous phase and produce a second dehydrated natural gas stream.

16. The method of claim 15, wherein contacting the first gaseous phase with the first absorbent comprises:
flowing the first absorbent across a first plurality of trays disposed in a first absorption tower; and
flowing the first gaseous phase across the first plurality of trays, wherein the first absorbent and the first gaseous phase flow through the first absorption tower in opposite directions.

17. The method of claim 16, wherein contacting the second gaseous phase with the second absorbent comprises:
flowing the second absorbent across a second plurality of trays disposed in a second absorption tower; and
flowing the second gaseous phase across the second plurality of trays, wherein the second absorbent and the second gaseous phase flow through the second absorption tower in opposite directions, wherein the second plurality of trays of the second absorption tower has a larger number of trays in comparison to the first plurality of trays of the first absorption tower.

18. The method of claim 17, wherein the flow-through electric generator comprises a stator, a rotor, and a hermetically sealed housing enclosing the turbine wheel, wherein the stator and the rotor are hermetically sealed inline in a flowline flowing the second portion of the natural gas stream, such that the second portion of the natural gas stream flows across the turbine wheel and the stator.

19. The method of claim 18, wherein the rotor comprises a permanent magnet rotor.

20. A system for processing a natural gas stream comprising a hydrocarbon and water from a natural gas well, the system comprising:
a flow-through turboexpander generator configured to receive a first portion of the natural gas stream and generate electrical power in response to expansion of the first portion of the natural gas stream flowing through the flow-through turboexpander generator;
a throttle valve configured to reduce a pressure of a second portion of the natural gas stream as the second portion of the natural gas stream flows through the throttle valve;
a knockout separator configured to receive the first portion of the natural gas stream from the flow-through turboexpander generator and configured to separate phases of the first portion of the natural gas stream to produce at least a gaseous phase and an aqueous phase; and
an absorption separator configured to receive the gaseous phase from the separator vessel and separate water from the gaseous phase to produce a dehydrated natural gas stream.
